(19) United States
(12) Patent Application Publication
(10) Pub. No.: US 2008/0104776 A1
(43) Pub. Date: May 8, 2008

(54) Process for Dyeing

(76) Inventors: Rainer Nusser, Neuenburg (DE); Markus Gisler, Rheinfelden (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/547,786

(22) PCT Filed: Apr. 1, 2005
(86) PCT No.: PCT/IB05/00846

§ 371 Date: Oct. 6, 2006

(30) Foreign Application Priority Data
Apr. 6, 2004 (EP) 04008292.7

(51) Int. Cl. C09B 7/00; D06P 1/38; D06P 3/02; D06P 3/66

(52) U.S. Cl. 8/506

(57) ABSTRACT

The present invention relates to a process for the bichromatic or the trichromatic dyeing or printing of hydroxy-group-containing or nitrogen-containing organic substrates with dye mixtures and also to such dye mixtures and hydroxy-group-containing or nitrogen- containing organic substrates dyed or printed therewith.

The present invention relates to a process for the bichromatic and/or trichromatic dyeing or printing hydroxy-group-containing or nitrogen-containing organic substrates with dye mixtures and also to such dye mixtures and hydroxy-group-containing or nitrogen-containing organic substrates dyed or printed therewith.

Trichromatic describes the additive colour mixing of suitable yellow- or orange-, red- and blue-dyeing dyes with which any desired shade in the visible spectrum can be obtained by suitably selecting the amount ratios for the dyes. However, it is possible to achive some shades by mixing only two colorants selected from a suitable yellow- or orange-, red- and blue-dyeing dye which is here called bichromatic dyeing.

Trichromatic and bichromatic dyeing is well known from the literature for various dye classes, for example from EP 83299, DE 2623178, EP 226982 and EP808940. Optimum trichromatic or bichromatic performance of any yellow (or orange), red and blue dye mixture is crucially dependent on the neutral affinity and migration characteristics. Dyes having identical or very similar characteristics with regard to neutral affinity and migration are highly compatible with regard to trichromatic or bichromatic performance.

It is an object of the present invention to provide a trichromatic or bichromatic dyeing process and associated trichromatic or bichromatic dye mixtures consisting of at least one red component, at least one yellow component or orange component or one blue component whereby trichromatic or bichromatic dyeing with good fastnesses is obtained.

This object is achieved by a trichromatic or bichromatic dyeing process which is characterized by using a dye mixture comprising a red-dyeing compound of the formula (I)

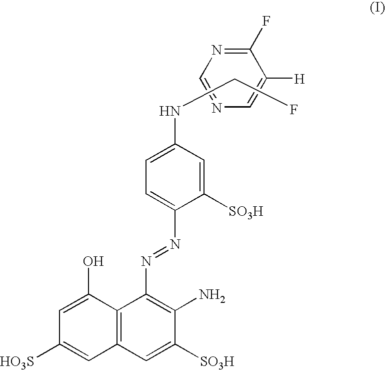

and at least one yellow-dyeing compound or orange-dyeing compound or one blue-dyeing compound.

In a further embodiment this object is achieved by a trichromatic dyeing process which is characterized by using a dye mixture comprising a red-dyeing compound of the formula (I) and at least one yellow-dyeing compound or orange-dyeing compound and at least one blue-dyeing compound.

Various auxiliaries, such as surface-active compounds, solubilising agents, thickeners, gel-forming substances, antioxidants, penetration agents, sequestering agents, buffers, light protection agents, care agents may additionally be present in the composition according to the invention.

Such auxiliaries are in particular wetting agents, antifoams, levelling agents, thickeners and plasticizers.

For the preparation of inks for printing processes suitable organic solvents or mixtures thereof are used. E.g. alcohols, ethers, esters, nitrites, carbonacidamides, cyclic amides, urea, sulfones and sulfone oxides.

Furthermore additional auxiliaries such as e.g. compounds, which adjust the viscosity and/ or the surface tension, may be added to the ink composition.

Suitable yellow-dyeing compounds or orange-dyeing compounds for the inventive trichromatic or bichromatic process have the following formula (II)

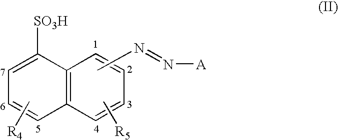

wherein
R₄ and R₅ signify independently from each other H or —SO₃H,
A signifies a group of formula (i) or (ia)

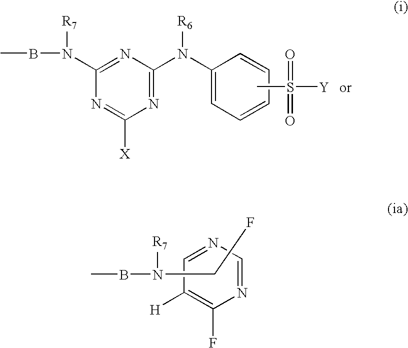

wherein
X is a halogen radical and
Y signifies —CH═CH₂ or —CH₂CH₂—Z, wherein Z is a radical which can be eliminated by alkali,
R₆ and R₇ signify independently from each other H; unsubstituted C₁₋₄alkyl or substituted C₁₋₄alkyl,
B signifies

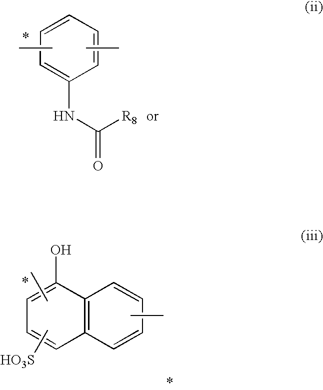

wherein R₈ signifies C₁₋₄alkyl; —NH₂ or —NHC₁₋₄alkyl, and the asterisk marks the bond to the —N═N—group.

A suitable radical Z which can be eliminated by alkali or under alkaline conditions, respectively, is for example chlorine; bromine or —OSO₃H or —SSO₃H or the alkali metal salt thereof; and by preference —OSO₃H or the alkali metal salt thereof.

Further suitable yellow-dyeing compounds or orange-dyeing compounds for the inventive trichromatic or bichromatic process have the following formula (IV)

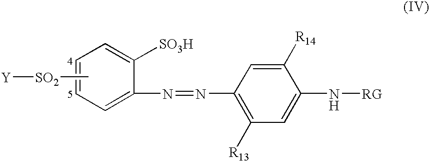

wherein
R₁₃ signifies H; methyl; methoxy, ethoxy; —NHCONH₂ or —NHCOCH₃,
R₁₄ signifies H; methyl; methoxy or ethoxy,
RG signifies

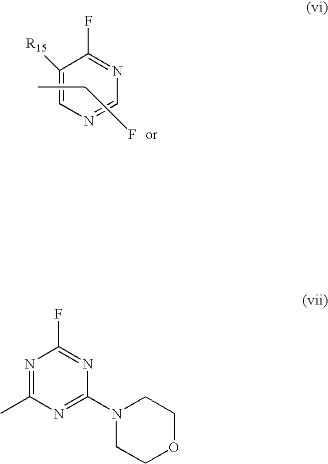

wherein
R₁₅ signifies H or chlorine,
Y signifies —CH═CH₂ or —CH₂CH₂—Z, wherein Z is a radical which can be eliminated by alkali, and may be bonded in the position 4 or 5 with respect to the azo group.

Suitable blue-dyeing compounds for the inventive trichromatic or bichromatic process have the following formula (V) or (VI)

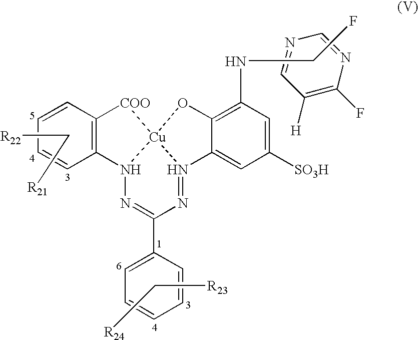

in which
R₂₁ is H or —COOH,
each of R₂₂ and R₂₄ is independently H; —COOH; —SO₃H; —NHCOCH₃; —NHCOCHY₂-CH₂Yl; -NHCOCY₂=CH₂ or —NHCOCH₂Y₁,
R₂₃—COOH,
Y₁ is chlorine; bromine; —OSO₃H or —SSO₃H and
Y₂ is H; chlorine or bromine.

Further suitable blue-dyeing compounds for the inventive trichromatic or bichromatic process have the following formula (VI)

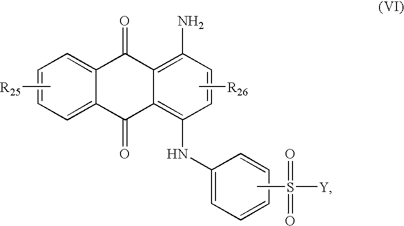

in which
Y signifies —CH═CH₂ or —CH₂CH₂—Z, wherein Z is a radical which can be eliminated by alkali,
R₂₅ signifies H or —SO₃H,
R₂₆ signifies H or —SO₃H.

Further suitable blue-dyeing compounds for the inventive trichromatic or bichromatic process have the following formula (VII)

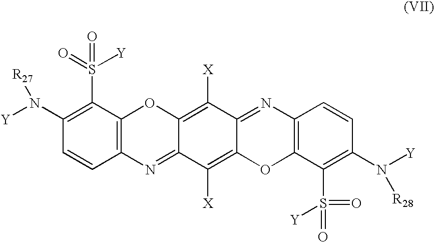

wherein
each Y has independently from each other the same meanings as defined above
R₂₇ and R₂₈ are independently from each other H; unsubstituted C₁₋₄alkyl or substituted C₁₋₄alkyl.

A preferred bichromatic dyeing process is characterized by using a dye mixture comprising a red-dyeing compound of the formula (I) and at least one yellow-dyeing compound or orange-dyeing compound of the formula (II), (III) and/or (IV)

A further preferred bichromatic dyeing process is characterized by using a dye mixture comprising a red-dyeing compound of the formula (I) and at least one blue-dyeing compound as per the formula (V), (VI), and/or (VII).

A preferred trichromatic dyeing process is characterized by using a dye mixture comprising a red-dyeing compound of the formula (I) and at least one yellow (or orange)-dyeing compound of the formula (II), (III) and/or (IV) and at least one blue-dyeing compound as per the formula (V), (VI), and/or (VII).

A more preferred trichromatic dyeing process is characterized by using a dye mixture comprising at least one yellow (or orange)-dyeing compound of formula (IIa), (IIb) and/or (IIc)

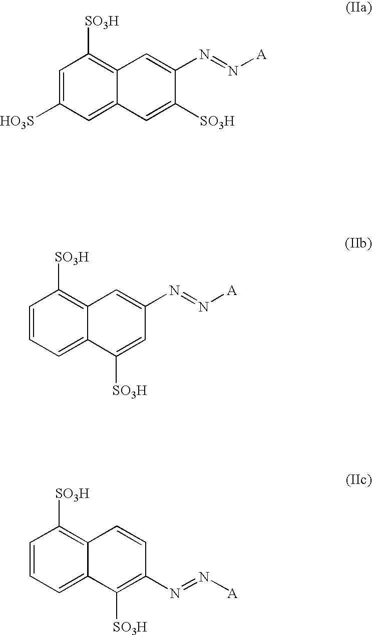

wherein A is

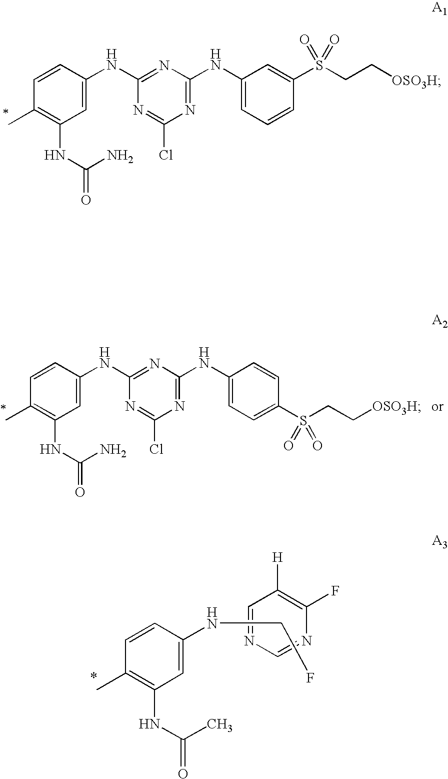

and/or at least one yellow-dyeing compounds or orange-dyeing compounds of formula (IVa) or (IVb)

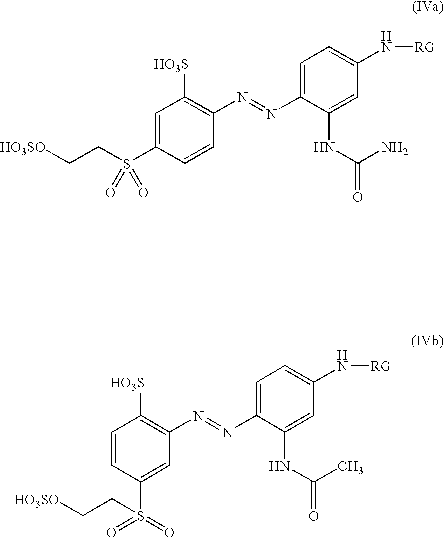

wherein RG is

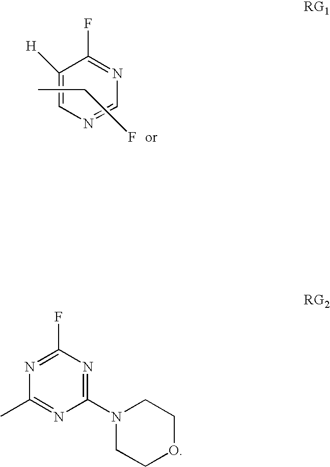

and/or at least one blue-dyeing compound of formula (Va) or (Vb)

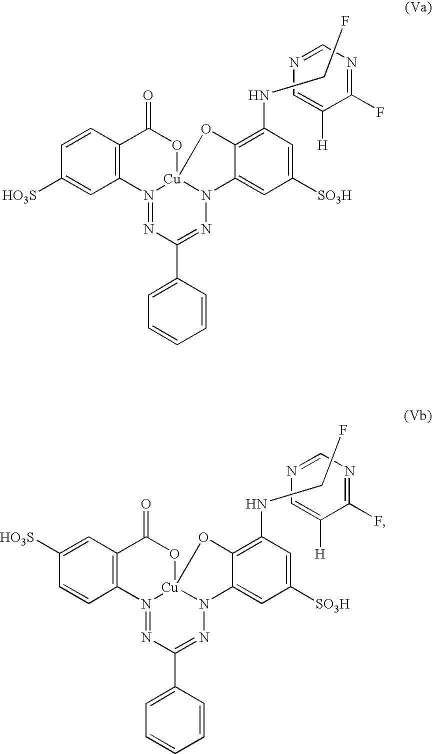

and/or at least one blue-dyeing compounds of formula (VIa) or (VIb)

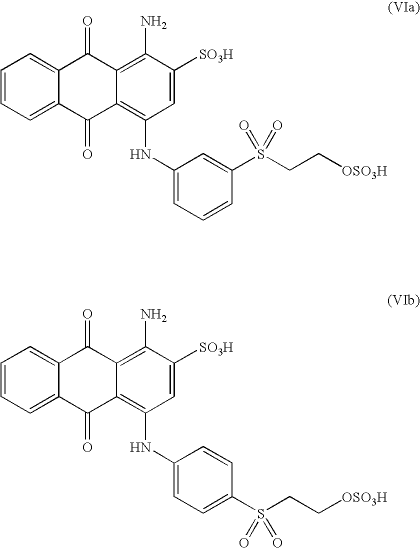

and/or at least one blue-dyeing compound of formula (VIIa)

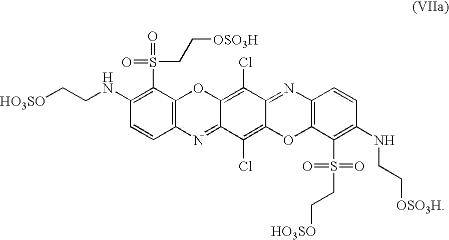

It is to be noted that all compounds may also be present in salt form. Useful salts include in particular alkali metal, alkaline earth metal or ammonium salts or the salts of an organic amine.

It is likewise to be noted that the alkyl groups can be linear or branched.

Suitable groups Z which may be eliminated by alkali in the group —SO₂—CH₂CH₂—Z are chlorine; bromine; —OSO₃H or —SSO₃H.

Preferred hydroxy-group-containing or nitrogen-containing organic substrates are leather and fibrous materials, which comprise natural or synthetic polyamides and, particularly, natural or regenerated cellulose such as, cotton, viscose and spun rayon. The most preferred substrates are textile materials comprising cotton.

The compound of the formula (I) is prepared according to EP962500.

The yellow-dyeing compounds or orange-dyeing compounds are known from the state of the art and can therefore be produced according to the process given in the prior art. E.g. WO96/02593 and F.Lehr, Dyes Pigm. (1990), 14(4), 257.

The blue-dyeing compounds are also known from the state of the art and can therefore be produced according to the process given in the prior art. E.g. EP 99721, EP84314, WO0168775, EP 149170, EP497174 and DE4241918.

This invention further provides dye mixtures for the trichromatic dyeing or printing of hydroxy-group-containing or nitrogen-containing organic substrates are used in the above processes according to the invention.

The inventive process for trichromatic dyeing or printing can be applied to all customary and known dyeing and printing processes, for example the continuous process, the exhaust process, the foam dyeing process and the ink-jet process.

The composition of the individual dye components in the trichromatic dye mixture used in the process according to the invention depends on the desired hue. For instance, a brown hue preferably utilizes 30-65% by weight of the yellow (or orange) component according to the invention, 10-30% by weight of the red component according to the invention and 10-30% by weight of the blue component according to the invention.

The red component, as described above, can consist of a single component or of a mixture of different red individual components.

The same applies to the yellow (or orange) and blue components.

The total amount of dyes in the process according to the invention is between 0.01 and 15% by weight, preferably between 1 and 10% by weight.

The present invention further provides hydroxy-group-containing or nitrogen-containing organic substrates dyed or printed by a dye mixture according to the invention.

The process according to the invention provides dyeings and prints having a homogeneous hue build-up throughout the entire hue spectrum with on-tone exhaustion, with a high bath exhaustion even in the case of fibres with low saturation and with a high dye build-up on fine fibres, particularly on microfibres.

The resulting dyeings or prints are notable for very high wet fastnesses, specifically the fastnesses in washing, perspiration and water. These good wet and fabrication fastnesses, which are in no way inferior to the fastness level of dyeings and prints with metal complexes, are obtained without aftertreatment. With an additional aftertreatment, these fastnesses are even exceeded.

These excellent results are provided by metal-free elements which meet the current and future ecological requirements of national institutes and regulations.

The tables which follow show some examples of the individual components of the dye mixtures which are used in the inventive trichromatic dyeing process.

TABLE 1
Examples 1-4
Example of yellow-dyeing compounds or orange-dyeing compounds of formula (II′)
according to formula (II)

| | |
|---|---|
| | (II′) |
| 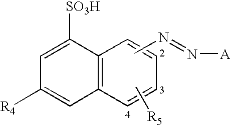 | |

| | | | | Position |
|---|---|---|---|---|
| Ex. | R₄ | R₅ | A | —N═N— |
| 1 | SO₃H | (3)-SO₃H | 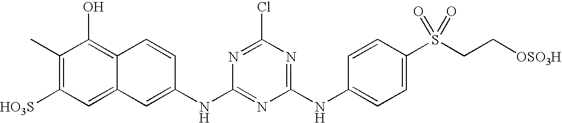 | 2 |
| 2 | SO₃H | (3)-SO₃H | 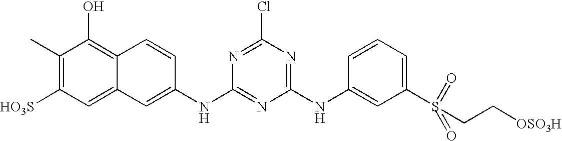 | 2 |
| 3 | H | (4)-SO₃H | 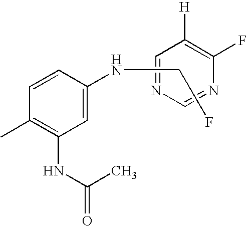 | 3 |
| 4 | SO₃H | (3)-SO₃H | 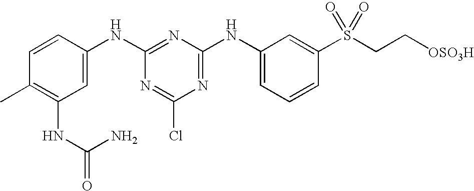 | 2 |

TABLE 2
Examples 5-7
Examples of yellow-dyeing compounds or orange-dyeing
compounds of formula (IV′) according to formula (IV)

| | |
|---|---|
| | (IV′) |
| 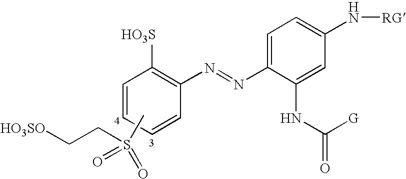 | |

| | Position | | |
|---|---|---|---|
| Ex. | —SO₂CH₂CH₂OSO₃H | G | RG′ |
| 5 | 4 | —NH₂ | 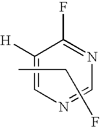 |
| 6 | 3 | —CH₃ | 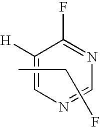 |
| 7 | 4 | —CH₃ | 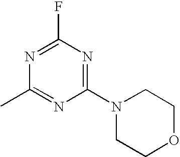 |

The application examples hereinbelow serve to illustrate the present invention. Parts are by weight and % are weight-%, unless otherwise indicated. Temperatures are in degrees Celsius, unless otherwise indicated.

### APPLICATION EXAMPLE 1

A 20 g sample of bleached cotton knitting. is transferred in a solution of 16 g sodium sulfate in 200 ml water at 60° C.,
0.5% (calculated on the fabric weight) of a red dye of formula (I)
0.8% of a yellow dye as per Example 4
0.5% of a blue dye as per Formula Va and
portions of 0.3, 0.7 and 1 g of sodium carbonate are added at 60° C. after 30, 45 respectively 60 minutes. The temperature is maintained during another 60 minutes. The dyed fabric is rinsed in hot distilled water during 2 minutes and in hot tap water during 1 minute. After being kept in 1000 ml distilled water at the boil for 20 minutes. the fabric is dried. It provides a brown cotton dyeing having good fastnesses.

### EXAMPLES 2-16

These examples are made analogous to Use Example 1, but by using dyestuff mixtures as mentioned below. The resulted shade is given in brackets.

### APPLICATION EXAMPLE 2 (olive shade)

0.2% of a red dye of formula (I)
0.4% of a yellow dye as per Example 4
0.6% of a blue dye as per Formula Va

### APPLICATION EXAMPLE 3 (brown shade)

0.3% of a red dye of formula (1)
0.9% of a orange dye as per Example 6
0.6% of a blue dye as per Formula Va

### APPLICATION EXAMPLE 4 (olive shade)

0.1% of a red dye of formula (I)
0.5% of a yellow dye as per Example 6
0.6% of a blue dye as per Formula Va

### APPLICATION EXAMPLE 5 (brown shade)

0.5% of a red dye of formula (I)
0.9% of a yellow dye as per Example 4
0.3% of a blue dye as per Formula VIIa

### APPLICATION EXAMPLE 6 (olive shade)

0.2% of a red dye of formula (I)
0.4% of a yellow dye as per Example 4
0.3% of a blue dye as per Formula VIb.

### APPLICATION EXAMPLE 7 (red shade)

0.2% of a red dye of formula (I)
0.4% of a yellow dye as per Example 4

### APPLICATION EXAMPLE 8 (reddish orange shade)

0.3% of a red dye of formula (I)
0.9% of a orange dye as per Example 6

### APPLICATION EXAMPLE 9 (orange shade)

0.1% of a red dye of formula (I)
0.5% of a yellow dye as per Example 6

### APPLICATION EXAMPLE 10 (red orange shade)

0.5% of a red dye of formula (I)
0.9% of a yellow dye as per Example 4

### APPLICATION EXAMPLE 11 (light orange shade)

0.2% of a red dye of formula (I)
0.4% of a yellow dye as per Example 4

### APPLICATION EXAMPLE 12 (violet blue shade)

0.2% of a red dye of formula (I)
0.6% of a blue dye as per Formula Va

### APPLICATION EXAMPLE 13 (violet blue shade)

0.3% of a red dye of formula (I)
0.6% of a blue dye as per Formula Va

### APPLICATION EXAMPLE 14 (reddish blue shade)

0.1% of a red dye of formula (I)
0.6% of a blue dye as per Formula Va

### APPLICATION EXAMPLE 15 (violet shade)

0.5% of a red dye of formula (I)
0.3% of a blue dye as per Formula VIIa

### APPLICATION EXAMPLE 16 (violet shade)

0.2% of a red dye of formula (I)
0.3% of a blue dye as per Formula VIa.

1. Trichromatic or bichromatic dyeing process for dyeing or printing hydroxy-group-containing or nitrogen-containing organic substrates characterized by using a dye mixture comprising at least one red-dyeing compound of the formula (I) 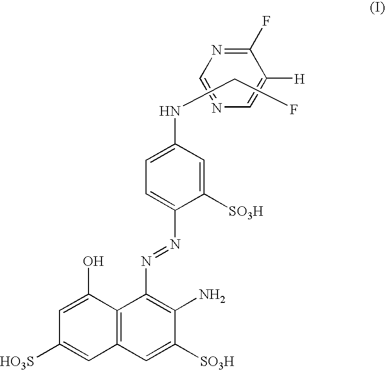
and at least one yellow-dyeing compound or orange-dyeing compound or one blue-dyeing compound.

2. Trichromatic dyeing process according to claim 1, characterized in that it comprises using a dye mixture comprising at least one yellow (or orange)-dyeing compound of the formula (II) 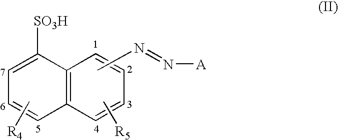
wherein
R₄ and R₅ signify independently from each other H or —SO₃H,
A signifies a group of formula (i) or (ia) 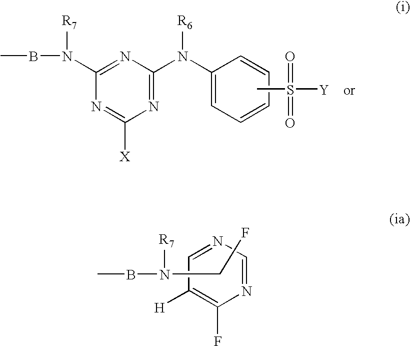
wherein
X is a halogen radical and
Y signifies —CH═CH₂ or —CH₂CH₂—Z, wherein Z is a radical which can be eliminated by alkali,
R₆ and R₇ signify independently from each other H; unsubstituted C₁₋₄alkyl or substituted C₁₋₄alkyl,
B signifies 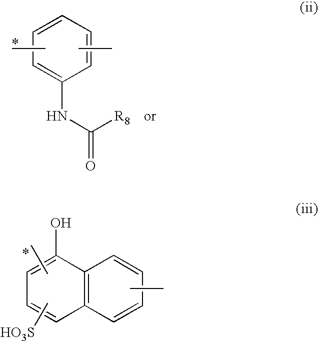
wherein R₈ signifies C₁₋₄alkyl; —NH₂ or —NHC₁₋₄alkyl,
and the asterisk marks the bond to the —N═N—group; and/or at least one yellow-dyeing compounds or orange-dyeing compounds of formula (IV) 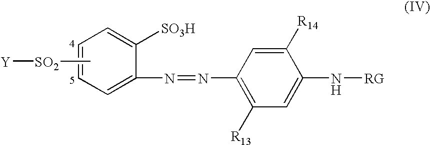
wherein
R₁₃ signifies H; methyl; methoxy, ethoxy; —NHCONH₂ or —NHCOCH₃,
R₁₄ signifies H; methyl; methoxy or ethoxy,
RG signifies 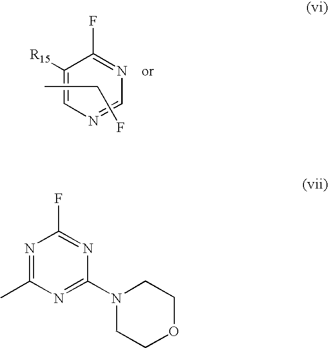
wherein
R₁₅ signifies H or chlorine,
Y signifies —CH═CH₂ or —CH₂CH₂—Z, wherein Z is a radical which can be eliminated by alkali, and may be bonded in a meta- or in para-position with respect to the azo group.

3. Trichromatic dyeing process according to claim 1, characterized in that it comprises using a dye mixture comprising at least one blue-dyeing compound of formula (VI) 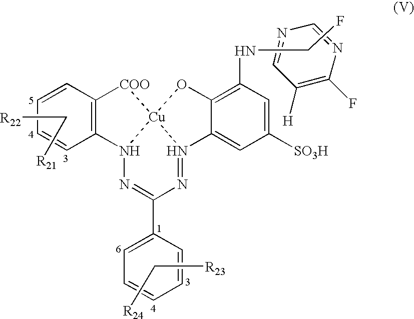
in which
R₂₁ is H or —COOH,
each of R₂₂ and R₂₄ is independently H; —COOH; —SO₃H; —NHCOCH₃; —NHCOCHY₂-CH₂Y₁; —N HCOCY₂=CH₂ or —N HCOCH₂Y₁,
R₂₃ —COOH,
Y₁ is chlorine; bromine; —OSO₃H or —SSO₃H and
Y₂ is H; chlorine or bromine;
and/or at least one blue-dyeing compound of formula (VI) 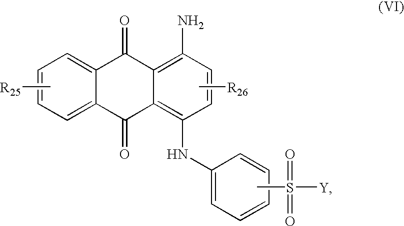
in which
Y signifies —CH═CH₂ or —CH₂CH₂—Z, wherein Z is a radical which can be eliminated by alkali,
R₂₅ signifies H or —SO₃H,
R₂₆ signifies H or —SO₃H;
and/or at least one blue-dyeing compound of formula (VII) 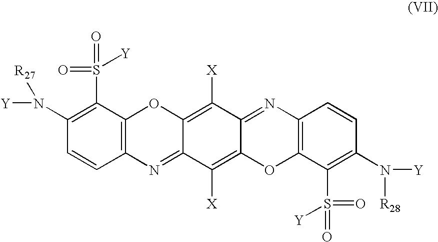
wherein
each Y signifies independently from each other —CH═CH₂ or —CH₂CH₂—Z, wherein Z is a radical which can be eliminated by alkali,
R₂₇ and R₂₈ are independently from each other H; unsubstituted C₁₋₄alkyl or substituted C₁₋₄alkyl.

4. Trichromatic dyeing process according to claim 1-3, characterized by using a dye mixture comprising at least one yellow (or orange)-dyeing compound of formula (IIa), (IIb) and/or (IIc) 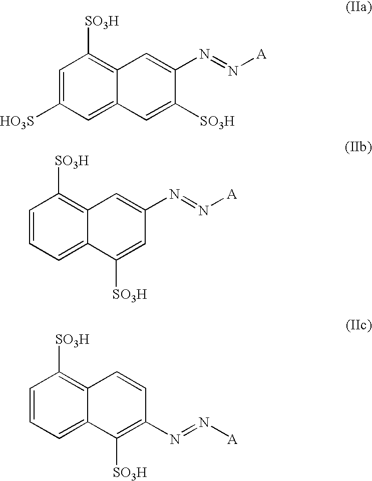
wherein A is 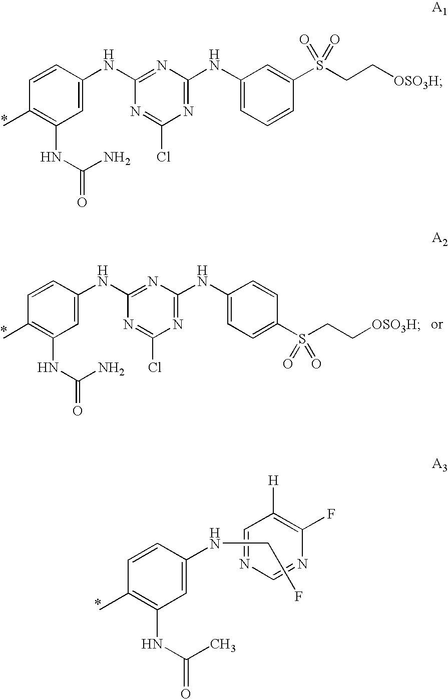
and/or at least one yellow-dyeing compounds or orange-dyeing compounds of formula (IVa) or (IVb) 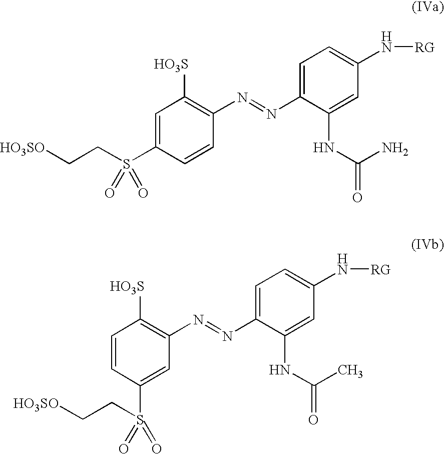
wherein RG is

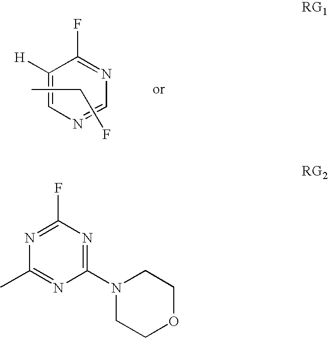

5. Trichromatic dyeing process according to claim 1-4, characterized by using a dye mixture comprising at least one blue-dyeing compound of formula (Va) or (Vb) 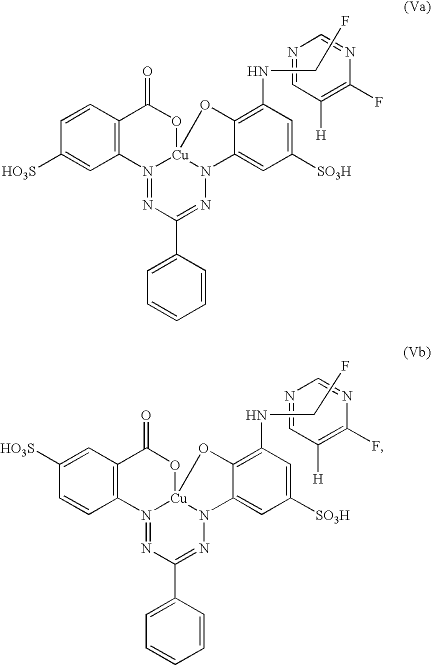
and/or at least one blue-dyeing compounds of formula (VIa) or (VIb) 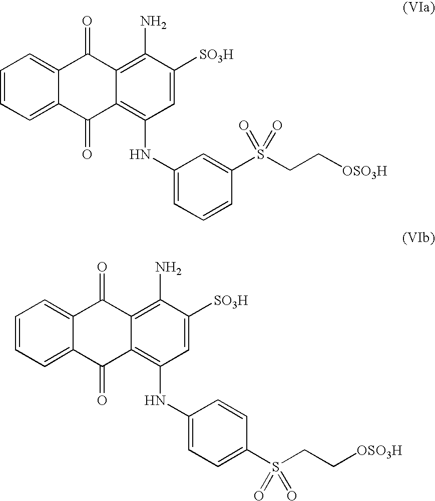
and/or at least one blue-dyeing compound of formula (VIIa)

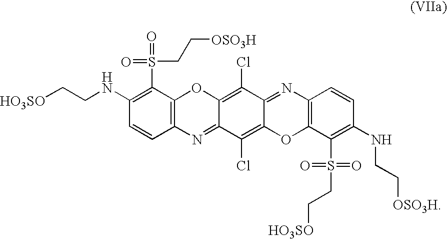

6. A dye mixture comprising at least one red-dyeing compound of the formula (I) 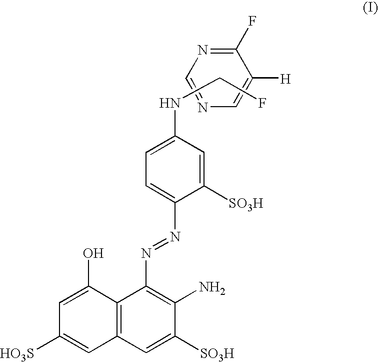
and at least one yellow-dyeing compound or orange-dyeing compound or one blue-dyeing compound wherein the at least one yellow (or orange)-dyeing compound is of the formula (II) 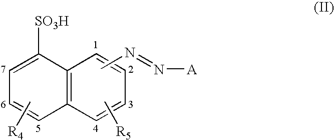
wherein
R₄ and R₅ signify independently from each other H or —SO₃H,
A signifies a group of formula (I) or (Ia) 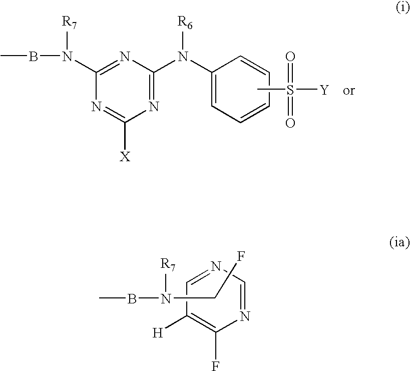
wherein
X is a halogen radical and
Y signifies —CH═CH₂ or —CH₂CH₂—Z, wherein Z is a radical which can be eliminated by alkali,
R₆ and R₇ signify independently from each other H; unsubstituted C₁₋₄alkyl or substituted C₁₋₄alkyl,
B signifies 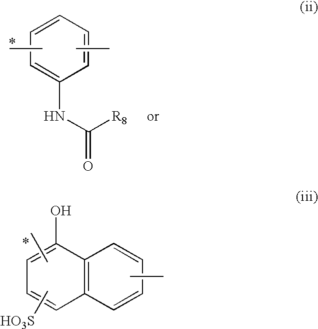
wherein R₈ signifies C₁₋₄alkyl; —NH₂ or —NHC₁₋₄alkyl,
and the asterisk marks the bond to the —N═N—group; and/or at the least one yellow-dyeing compounds or orange-dyeing compounds is of formula (IV) 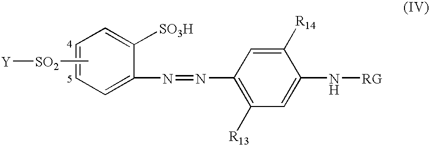
wherein
R₁₃ signifies H; methyl; methoxy, ethoxy; —NHCONH₂ or —NHCOCH₃,
R₁₄ signifies H; methyl; methoxy or ethoxy,
RG signifies 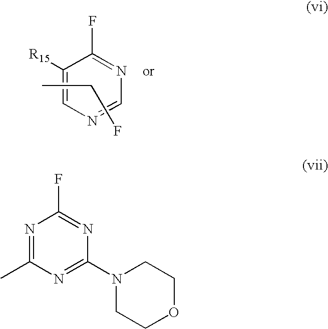
wherein
R₁₅ signifies H or chlorine,
Y signifies —CH═CH₂ or —CH₂CH₂—Z, wherein Z is a radical which can be eliminated by alkali, and may be bonded in a meta- or in para-position with respect to the azo group.
and the at least one blue-dyeing compound is of formula (VI) 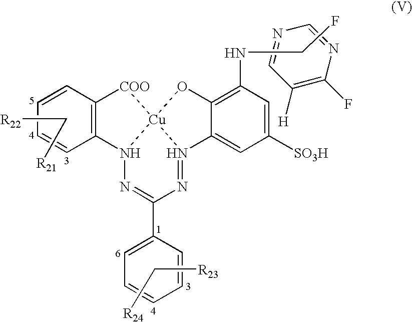
in which
R₂₁ is H or —COOH,
each of R₂₂ and R₂₄ is independently H; —COOH; —SO₃H; —NHCOCH₃; —NHCOCHY₂-CH₂Y₁; —NHCOCY₂=CH₂ or —NHCOCH₂Y₁,
R₂₃ —COOH,
Y₁ is chlorine; bromine; —OSO₃H or —SSO₃H and
Y₂ is H; chlorine or bromine;
and/or the at least one blue-dyeing compound is of formula (VI) 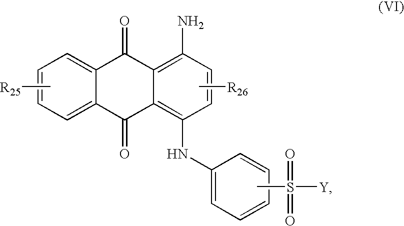
in which
Y signifies —CH═CH₂ or —CH₂CH₂—Z, wherein Z is a radical which can be eliminated by alkali,
R₂₅ signifies H or —SO₃H,
R₂₆ signifies H or —SO₃H;
and/or the at least one blue-dyeing compound is of formula (VII) 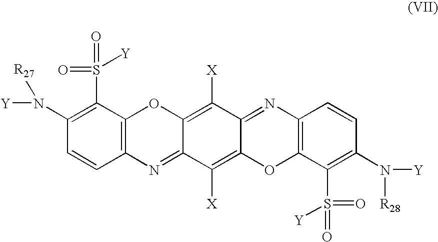
wherein
each Y signifies independently from each other —CH═CH₂ or —CH₂CH₂—Z, wherein Z is a radical which can be eliminated by alkali,
R₂₇ and R₂₈ are independently from each other H; unsubstituted C₁₋₄alkyl or substituted C₁₋₄alkyl.

7. A dye mixture according to claim 6, characterized in that the at least one yellow (or orange)-dyeing compound is of formula (IIa), (IIb) and/or (IIc) 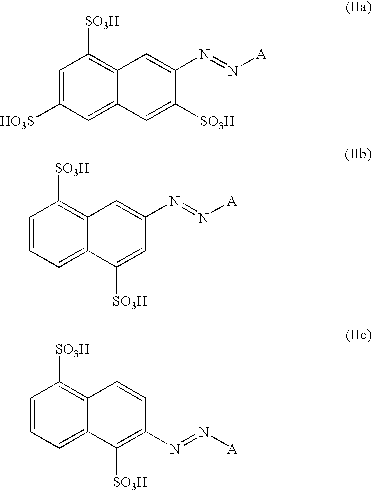
wherein A is 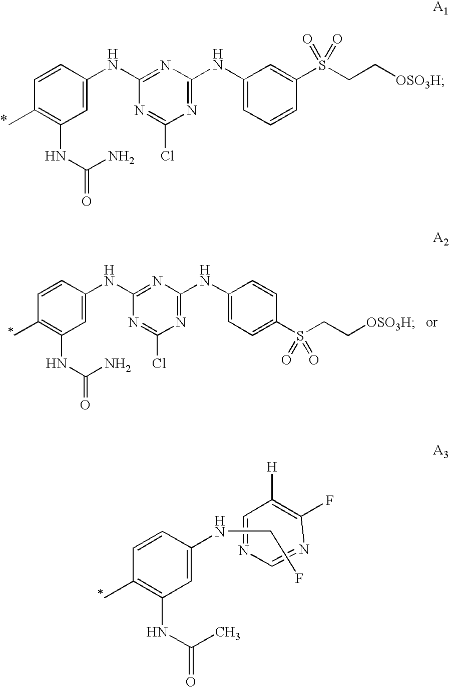
and/or at least one yellow-dyeing compounds or orange-dyeing compounds of formula (IVa) or (IVb) 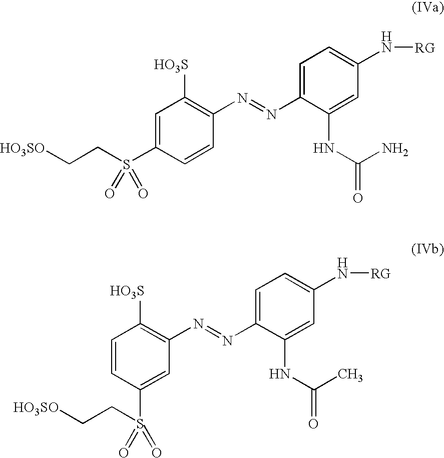
wherein RG is

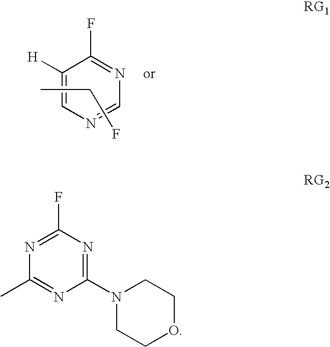

8. A dye mixture according to claim 6, characterized in that the at least one blue-dyeing compound is of formula (Va) or (Vb) 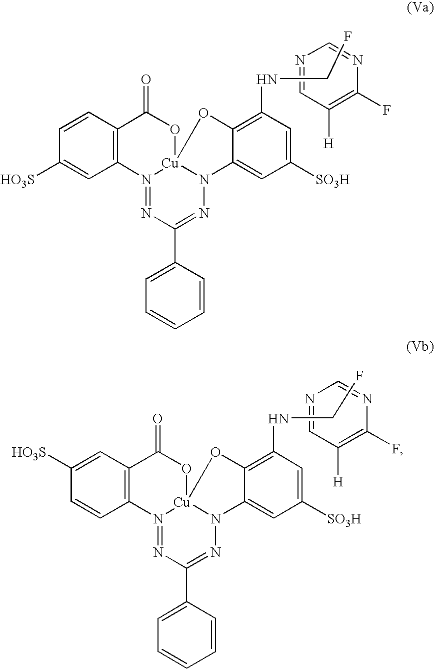
and/or at least one blue-dyeing compounds of formula (VIa) or (VIb) 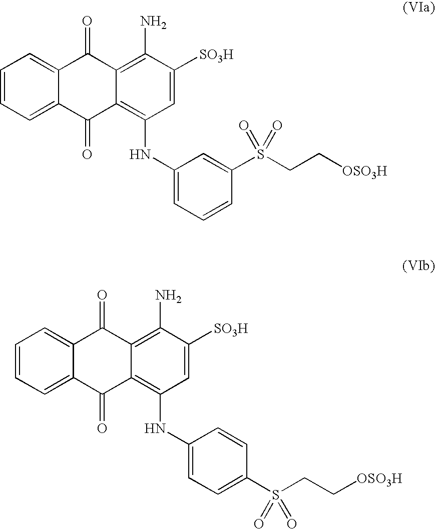
and/or at least one blue-dyeing compound of formula (VIIa)

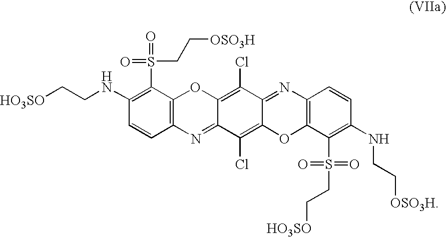

9. Substrates consisting of hydroxy-group-containing or nitrogen-containing organic substrates dyed or printed by a trichromatic dyeing process as claimed in any of claims 1-5.

10. Substrates consisting of hydroxy-group-containing or nitrogen-containing organic substrates dyed or printed with a dye mixture according to any of claims 6-8.
